(19) United States
(12) Patent Application Publication
(10) Pub. No.: US 2008/0209435 A1
(43) Pub. Date: Aug. 28, 2008

(54) Scalable workflow management system

(75) Inventors: George R. Dong, Issaquah, WA (US); Jeffrey A. Wang, Seattle, WA (US); Lan Chen, Bellevue, WA (US); Jin Wang, Kirkland, WA (US); Anton P. Pavlovich Amirov, Redmond, WA (US); Sanjay Jacob, Redmond, WA (US); Zhenyu Tang, Sammamish, WA (US); Patrick J. Baumgartner, Pullman, WA (US); Xiaohong Yang, Sammamish, WA (US); Rou-Peng Huang, Woodinville, WA (US); Robert L. Vogt, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/710,154

(22) Filed: Feb. 23, 2007

(51) Int. Cl. G06F 9/45

(52) U.S. Cl. 718/106

(57) ABSTRACT

A scalable workflow management system is provided that includes queues for storing work items to be processed. Work items may be placed into the queues by front-end services executing within the workflow management system. When a work item is placed on a queue, it remains on the queue until an appropriate back-end service is available to de-queue the work item, validate the de-queued work item, and process the de-queued work item. Separate queues are provided for storing normal work items, work items generated according to a time schedule, and work items generated by job launching services. The state of operation of the workflow management system may be controlled by an administrative console application.

### BACKGROUND

Workflow management (“WFM”) systems are computing systems that provide functionality for modeling business processes along with the ability to implement and monitor the procedural and computational aspects of each process. For example, a corporation may utilize a WFM system to model a business process for generating a rolling forecast for sales generated by the organization. As part of the modeling process, the employees of the corporation that submit data as a part of the process are identified, as are the supervisors that are responsible for approving or rejecting the data submitted by the employees.

When such a model is executed by a WFM system, the system utilizes the model to manage the procedural aspects of the process. For instance, a request for the submission of data may be generated and transmitted to the employees identified by the model as being responsible for supplying the data. When the data is submitted, it is stored in a database for use in business reporting and business calculations also defined within the model. An appropriate supervisory employee may also be requested to approve the submission. For instance, in the rolling sales forecast example, one employee may be responsible for submitting sales figures for North America while another employee is responsible for submitting sales figures for Europe. These figures may then be stored in a database for use in business reporting and business calculations performed by the WFM system, such as using the figures to compute a worldwide sales figure. Appropriate supervisory employees within the organization may be required to approve the submissions.

Previous WFM systems are often unable to maintain high performance operation when the number of concurrent work items, like database writeback operations, increases dramatically. For instance, such previous solutions may be able to provide acceptable performance during normal levels of activity. However, when the activity level spikes dramatically, such as during end-of-month processing, previous WFM systems may become unresponsive. Moreover, previous WFM systems may be limited in their ability to allow the operational state of the WFM system to be controlled. For instance, in previous WFM systems it may be very difficult to take the WFM system offline without losing data.

It is with respect to these considerations and others that the disclosure made herein is provided.

### SUMMARY

Technologies are described herein for providing a scalable WFM system. Through aspects presented herein, the performance of a WFM system may be scaled to allow highly responsive operation even as the number of concurrently submitted work items, such as writeback operations, increases dramatically. Moreover, through other aspects described herein, the operational state of a WFM system may be easily controlled to thereby specify the time periods in which data may be submitted to the WFM system or to take the entire WFM system offline without the risk of losing valuable data.

According to one aspect presented herein, a scalable WFM system is provided that includes a multi-tiered architecture that provides significant performance improvements as compared to previous WFM systems. In one tier, queues for storing work items submitted to the WFM system are provided. For instance, a queue may be provided for temporarily storing writeback operations that include data submitted by a user of the WFM system. Work items may be queued by front-end services executing within another tier of the WFM system. When a work item is placed on the queue, it remains there until a back-end service can de-queue the work item, validate the de-queued work item, and process the de-queued work item. By queuing work items in this manner in a WFM system, the WFM system can be scaled to maintain responsiveness to client applications or services queuing work items, even when the back-end services responsible for actually processing the work items are operating under a heavy load. Moreover, more back-end services can be dynamically added to offload the processing load.

According to another aspect presented herein, a scalable WFM system is provided that includes multiple queues for storing work items. A normal queue is provided for storing normal work items, such as user writeback operations, that are generated asynchronously. A scheduler queue is provided for storing work items that are generated according to a time schedule. For instance, a front-end service may be utilized within the WFM system that instantiates work items according to a time schedule defined within the business process. A job queue is also provided for storing work items generated by job launching services executing within the WFM system. More than one queue may be delegated for performing the same type of work.

According to yet another aspect presented herein, a WFM system is provided that can be operated in one of several states of operation. In particular, the WFM system may be operated in an online state wherein work items can be placed onto the queues and removed from the queues. The WFM system may also be placed in an asynchronous offline state wherein work items may be placed onto the queues, but not removed from the queues. The WFM system may also be placed in a locked state, wherein users of the WFM system may read data from the WFM system but not write data. The WFM system can be transitioned between the various states of operation without losing data in the queues. The state of operation of the WFM system can be controlled from an administrative console application program.

The above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network diagram showing an illustrative network computing architecture utilized in one embodiment described herein;

FIG. 2 is a software architecture diagram showing an illustrative software architecture for implementing a scalable WFM system in one implementation described herein;

FIG. 3 is a software architecture diagram illustrating an exemplary architecture for service broker queues provided in one implementation described herein;

FIG. 4 is a flow diagram showing an illustrative process for providing a scalable WFM system in one implementation described herein;

FIG. 5 is a state diagram showing an illustrative process for controlling the state of a WFM system in one embodiment presented herein; and

FIG. 6 is a computer architecture diagram showing an illustrative hardware architecture suitable for implementing the computing systems described with reference to FIGS. 1-5.

### DETAILED DESCRIPTION

The following detailed description is directed to technologies for providing a high-performance, scalable WFM system. As will be discussed in greater detail below, a multi-tiered WFM system is provided herein that can be scaled to improve application performance as the number of work items submitted to the system increases. Moreover, the state of operation of the WFM system provided herein can be managed through the use of an administrative console application to modify the operational state of the WFM system as needed.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

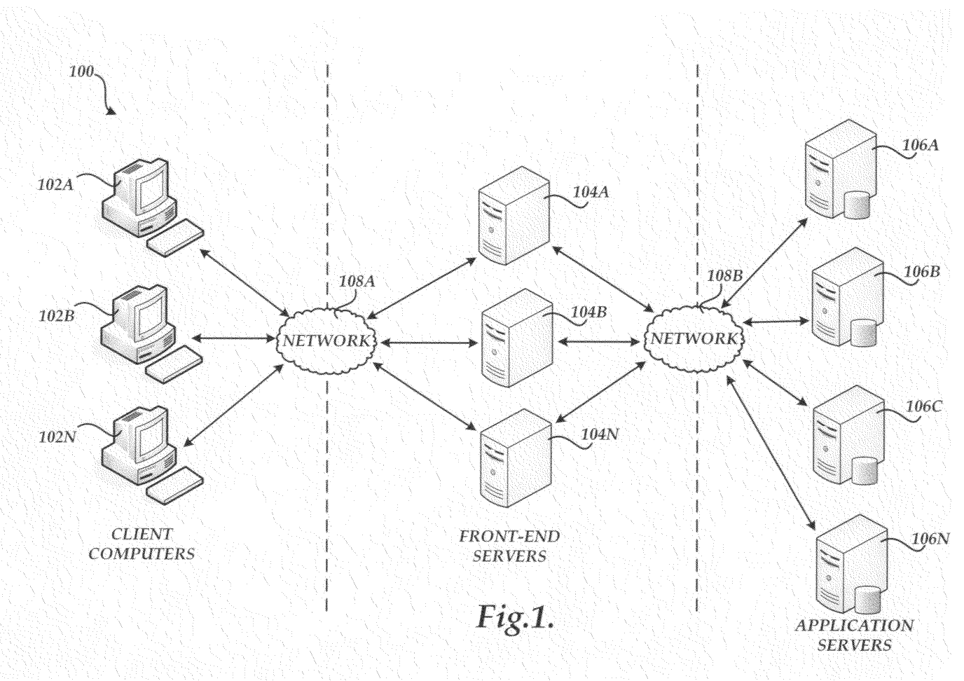

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for providing a scalable WFM system will be described. In particular, FIG. 1 is a network diagram showing an illustrative network computing architecture 100 that may be utilized as an operating environment for an implementation of a WFM system presented herein.

The illustrative network computing architecture 100 shown in FIG. 1 is a multi-tiered network architecture. In particular, a first tier includes the client computers 102A-102N. The client computers 102A-102N are general-purpose desktop or laptop computers capable of connecting to the network 108A and communicating with the front-end servers 104A-104N. The client computers 102A-102N are also equipped with application software that may be utilized to receive information from a WFM system and to submit data thereto. For instance, according to embodiments, the client computers 102A-102N include an electronic mail (“e-mail”) application program and a Web browser application program for receiving e-mail from a WFM system and for viewing and interacting with a Web site provided by a WFM system, respectively. The client computers 102A-102N may also include a spreadsheet application program for generating data for submission to a WFM system. It should be appreciated that the client computers 102A-102N may include other types of application software for interacting with a WFM system, for viewing data received from a WFM system, and for creating data for submission to a WFM system.

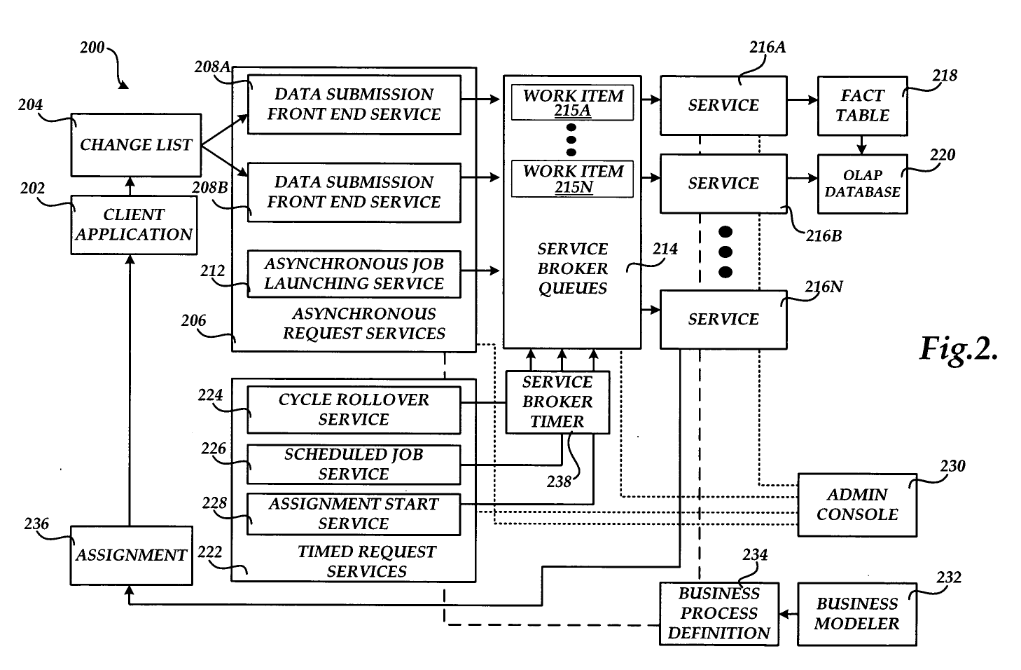

The second tier of the network computing architecture 100 shown in FIG. 1 includes the front-end servers 104A-104N. The front-end servers 104A-104N are general-purpose server computers operative to connect to the networks 108A and 108B, and to communicate with the client computers 102A-102N and the application servers 106A-106N via these networks. As will be described in greater detail below, the front-end servers 104A-104N are also operative to execute software services utilized in the provision of a WFM system. For example, the front-end servers 104A-104N may execute a data submission front-end service that is operative to receive work items in the form of data submissions from the client computers 102A-102N, and to queue the work items for processing by other services. The other services executing on the front-end servers 104A-104N are described in greater detail below with respect to FIG. 2.

The third tier of the network computing architecture 100 shown in FIG. 1 includes the application servers 106A-106N. The application servers 106A-106N are connected to the network 108B and are operative to communicate with the front-end servers 104A-104N thereby. The application servers 106A-106N are also operative to execute application programs and other back-end services for use in a WMF system. For instance, as will be described in greater detail below, the application servers 106A-106N may execute services for de-queuing and processing work items in the WMF system. Applications may also be executed on the application servers 106A-106N. For instance, a relational database application program may be executed on the application servers 106A-106N or providing functionality for storing and querying data related to business processes executing within the WMF systems. Additional details regarding the software components executing on the application servers 106A-106N will be described in greater detail below.

It should be appreciated that while FIG. 1 shows three client computers 102A-102N, three front-end servers 104A-104N, and four application servers 106A-106N, virtually any number of these computer systems may be utilized. In particular, the execution of the software components described below with respect to FIG. 2 may be distributed across any number of front-end servers 104A-104N and application servers 106A-106N. Alternatively, the software components may be executed as threads on a single server computer. The network computing architecture 100 shown in FIG. 1 may also be scaled by adding additional front-end servers 104A-104N or application servers 106A-106N as required to maintain performant operation of the system. The software components described herein are capable of scaling from execution on one to many server computer systems.

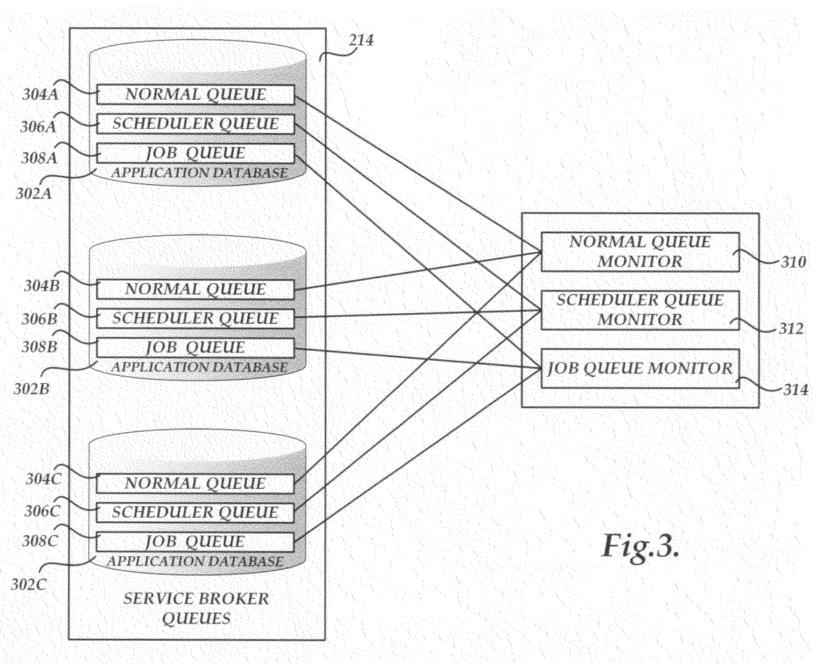

As discussed above, several queues may be maintained for storing work items within a WMF system prior to processing. In the case of the three-tiered network architecture shown in FIG. 1, these queues are maintained at the front-end servers 104A-104N. Alternatively, these queues may be maintained at the application servers 106A-106N. These queues may also be maintained at another computing system specifically dedicated to storing the queues. In one implementation, the queues are maintained in a relational database. In this regard, the queues may be maintained within an application database or in a separate, dedicated relational database. Additional details regarding the structure and use of the queues are provided below with respect to FIGS. 2-3.

FIG. 2 is a software architecture diagram showing an illustrative software architecture 200 for implementing a scalable WFM system in one embodiment presented herein. As will be described in detail below, the software architecture 200 may be utilized to provide a high-performance scalable WFM system. As discussed briefly above with respect to FIG. 1, the software components shown in FIG. 2 and described below may be scaled onto more or fewer server computers than shown in order to provide a desired level of performance for the WFM system.

The exemplary WFM system illustrated in FIG. 2 includes a business modeler application program 232. The business modeler application program 232 provides functionality for creating a business process definition 234. The business process definition 234 contains metadata that describes a business process, including its procedural and computational aspects, timing, participants, and other data. The business process definition 234 is utilized by the various software components shown in FIG. 2 to generate assignments to participants in the business process, to obtain approval for data submitted by participants, to perform business calculations and reporting, and to otherwise facilitate implementation of the modeled business process. Although only a single business process definition 234 is illustrated in FIG. 2, it should be appreciated that many business process definitions may be utilized concurrently and that the software architecture 200 is capable of simultaneously executing multiple business processes.

The metadata contained in the business process definition 234 defines the procedural aspects of a business process in terms of cycles and assignments. A cycle defines the scenario for the business process and the window of time in which the business process should be executed. Cycles may be defined as occurring one time only or as recurrent cycles. For instance, a recurring cycle may be defined for calculating sales figures that recurs at the beginning of each month. A cycle may be locked, unlocked, opened, or closed independently of other cycles.

Assignments are work activities that are defined within each cycle. An assignment may be made to a single user or a group of users. A set of data entry forms may also be associated with an assignment. For example, an assignment may require that a user provide a sales figure using a specified data entry form. Because assignments belong to cycles, different instances of the same assignment are created for different cycles. In this manner, the same assignment may exist concurrently in multiple cycles. Assignments may also contain properties specifying an approval chain or other validation rules that a data submission associated with the assignment must pass through for the assignment to be completed.

Jobs may also be generated by services executing within the WFM system as part of a cycle or assignment. For instance, a scheduled job service 226 may execute within the WFM system for launching jobs according to a schedule. As an example, the scheduled job service 226 may launch a job for generating a report according to a schedule set forth in the business process definition 234. Another job may be periodically instantiated for reprocessing the contents of a database, such as the online analytical processing (“OLAP”) database 220.

Cycles, assignments, and jobs may generate work items 215 in conjunction with their execution. Work items 215 are tasks that must be performed as a part of the execution of a cycle, assignment, or job within a modeled business process. For instance, a work item 215 may constitute a database writeback operation performed in response to the submission of data to the WFM system by a user. In order to remain responsive to user submissions, the WFM system must process work items 215 in an efficient manner. If work items 215 cannot be processed efficiently, an undesirable delay may be imposed upon users of the WFM system during data submission.

In order to process work items 215 in an efficient manner, the WFM system illustrated in FIG. 2 utilizes one or more service broker queues 214. The service broker queues 214 are first-in/first-out (“FIFO”) queues or priority queues that may be utilized by services executing within the WFM system to hold work items 215. In the illustrative architecture shown in FIG. 2, several types of services may queue work items 215 on the service broker queues 214. In particular, asynchronous request services 206 and timed request services 222 can place work items 215 on the queues 214.

The asynchronous request services 206 place work items 215 on the queues 214 asynchronously, and include the data submission front-end services 208A-208B and the asynchronous job launching service 212. The data submission front-end services 208A-208B receive data submissions form client applications and place appropriate work items 215 for the submitted data on the queues 214. The number of data submission front-end services 208A-208B may be scaled to handle a large number of client data submissions and other types of client requests such as reporting or what-if analysis. The asynchronous job launching service 212 is utilized to asynchronously place work items 215 on the queues 214 corresponding to system jobs.

The timed request services 222 place work items 215 on the queues 214 according to a time schedule. For instance, the cycle rollover service 224 is responsible for creating a new instance of a cycle according to a recurrence pattern defined within the cycle. In a similar fashion, the assignment start service 228 is responsible for instantiating new scheduled assignments. The scheduled job service 226 is responsible for instantiating jobs according to a specified time schedule. For instance, the scheduled job service 226 may queue work items for performing business calculations or performing outbound recording. Each of the services 224, 226, and 228, place the appropriate work items 215 on the queues 214 using the service broker timer 238. The service broker timer 238 ensures that the work items 215 are placed on the appropriate queue at the appropriate time. Because work items 215 are placed on the queues 214, rather than being directly consumed by back-end services, a high level of responsiveness to client applications can be maintained.

It should be appreciated that the events and jobs executing within the WFM system presented herein may have a cascading effect that triggers the execution of other events and jobs. For instance, the execution of a cycle may start a work item that instantiates various jobs and assignments. The jobs and assignments, in turn, may set and queue timed events for other jobs and assignments to begin. It should be appreciated that many cycles, work items, assignments, and jobs may trigger other objects in a similar manner.

The work items 215 placed on the queues 214 are de-queued and processed by other services executing within the WFM system. In particular, the services 216A-216N (which may be referred to herein as back-end services) are responsible for de-queuing work items 215, validating the work items 215, and performing processing as indicated by the work items 215. The services 216A-216N de-queue work items 215 as computational capabilities are made available. Moreover, the services 216A-216N can scale to multiple computing systems, thereby providing flexibility to add new hardware to the WFM system shown in FIG. 2 to increase performance.

To illustrate the use of the queues 214, the generation and processing of an illustrative data submission assignment 236 will now be described. In this example, a business process definition 234 indicates that the assignment 236 should be instantiated as part of a cycle. The cycle rollover service 224 is responsible for instantiating the cycle and the assignment start service 228 is responsible for instantiating the assignment 236. Once the assignment 236 has been instantiated, the assignment 236 is provided to a user of the WFM system. As mentioned briefly above, an e-mail client application, a Web browser application, or another type of application program capable of displaying the assignment 236 to a user may be utilized to view the assignment 236.

In response to receiving the assignment 236, a user may generate data that should be stored in the fact table 218 and the OLAP database 220. For instance, a user may utilize a client application 202, such as a spreadsheet application program, to generate the requested data. In one implementation, this data is represented as an extensible markup language (“XML”) change list 204 that includes data describing how the generated data should be stored within the fact table 218 and the OLAP database 220. It should be appreciated, however, that the change list 204 may comprise any type of package or document format. It may also be compressed and/or encrypted to allow more efficient and secure network transmission. It should also be appreciated that, in addition to the change list 204, the client application 202 may also submit one or more documents that support the contents of the change list 204. For instance, a spreadsheet document that includes the underlying computations utilized to arrive at the contents of the change list 204 may be submitted. A back-end service executing within the WFM system can verify the contents of the supporting documents and store the documents in an appropriate database or document library within the WFM system.

When the user submits the data requested in the assignment 236 to the WFM system, the change list 204 is received by one of the data submission front-end services 208A-208B. In response thereto, the front-end service that receives the change list 204 places a database writeback work item 215 on the service broker queues 214 indicating that the change list 204 should be applied to the fact table 218 and the OLAP database 220. The appropriate service 216A de-queues the database writeback work item 215 from the queues 214 and processes the work item 215. In this example, the service 216A makes the appropriate change in the fact table 218. Another service 216B may be executed by the scheduled job service 226 for periodically reprocessing the contents of the fact table 218 into the OLAP database 220. Additional details regarding the structure and use of the queues 214 will be provided below with respect to FIG. 3.

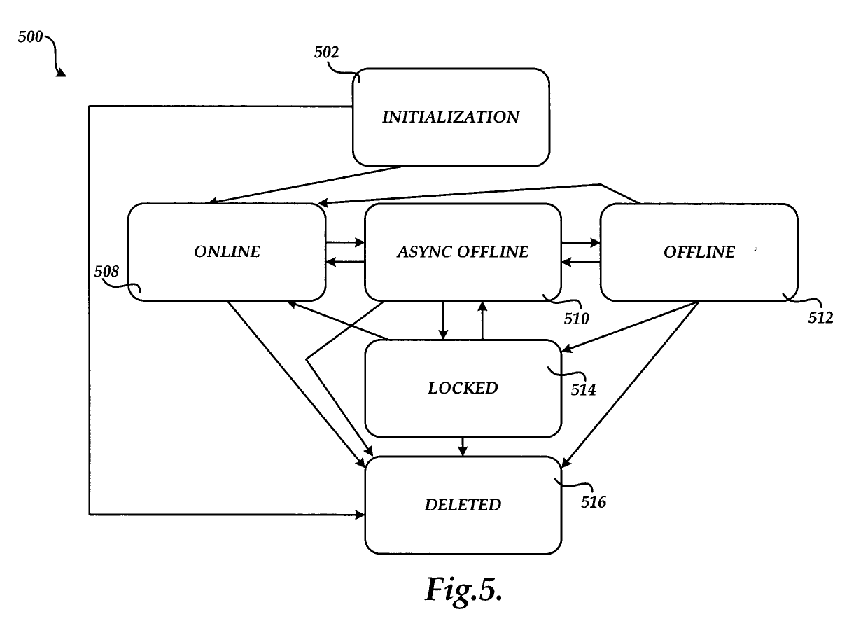

According to embodiments, the software architecture 200 also includes an administrative console application program 232. The administrative console application program 230 communicates with the various services and software components described above to control the state of operation of the WFM system embodied by the software architecture 200. For instance, a system administrator may utilize the administrative console application program 232 to place the WFM system online or to lock the operation of the WFM system. Additional details regarding the operation of the administrative console application program 232 with regard to changing the state of the WFM system shown in FIG. 2 are provided below with respect to FIG. 5.

FIG. 3 is a software architecture diagram showing one illustrative architecture for the service broker queues 214 in one implementation described herein. In the illustrative software architecture shown in FIG. 3, multiple queues are utilized. In particular, individual queues are provided within each application database 302A-302C. Within each application database 302A-302C, a normal queue 304 is provided for storing normal work items, such as work items for user data submissions. A scheduler queue 306 is also provided within each application database 302A-302C for storing work items 215 that are generated according to a time schedule. A job queue 308 is also provided within each application database 302A-302C for storing work items 215 generated by job launching services executing within the WFM system, such as the asynchronous job launching service 212. It should be appreciated that other types of queues, such as a trace log queue or an audit message queue, may also be added to the system to provide additional functionalities.

Within the WFM system, three queue monitors are provided for monitoring the queues 304A-304C, 306A-306C, and 308A-308C. In particular, the normal queue monitor 310 monitors the normal queues 304A-304C, the schedule queue monitor 312 monitors the scheduler queues 306A-306C, and the job queue monitor 314 monitors the contents of the job queues 308A-308C. In one implementation, each queue monitor instantiates multiple threads for handling queued work items. For instance, threads may be instantiated for de-queuing work items from the appropriate queue, validating the work item, executing the work item, and updating the status of the work item on the appropriate queue. Each monitor may also utilize a fairness algorithm to pick the right application queue from which the next work item should be de-queued.

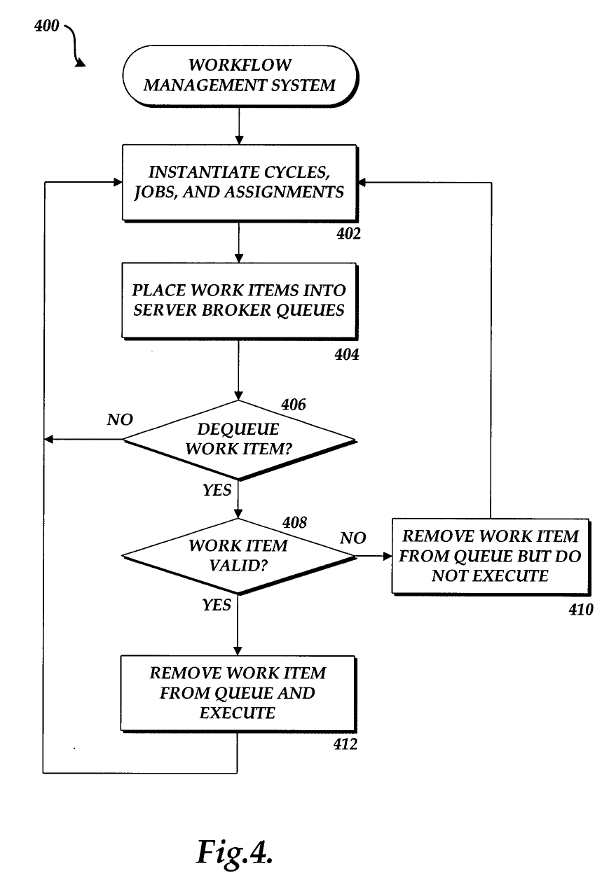

Referring now to FIG. 4, additional details will be provided regarding the embodiments presented herein for providing a scalable WFM system. In particular, FIG. 4 is a flow diagram showing a routine 400 that illustrates the use of the queues 214 within a scalable WFM system provided in one implementation described herein. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in FIG. 4 and described herein. These operations may also be performed in a different order than those described herein with respect to FIG. 4.

The routine 400 begins at operation 402, where cycles, assignments, and jobs are instantiated by the WFM system in the manner described above. As discussed above, the cycles, assignments, and jobs are defined by the business process definition 234 and instantiated by the various services executing within the WFM system, such as the cycle rollover service 224 and the assignment start service 228. Once the appropriate cycles, assignments, and jobs have been instantiated, the routine 400 continues to operation 404.

At operation 404, work items are placed onto the service broker queues 214 by the cycles, assignments, and jobs. For instance, as described above, a user data submission may result in a work item 215 being placed on the service broker queues by one of the data submission front-end services 208A-208B. Other services may place work items on the service broker queues 214 in a similar manner. From operation 404, the routine 400 continues to operation 406, where the queue monitors 310, 312, and 314 determine if work items 215 are present in the queue 214 that should be de-queued. If no work items 215 are presented for de-queuing, the routine 400 returns to operation 402 where additional assignments and jobs may be instantiated. If work items 215 are present in the queues 214 for de-queuing, the routine 400 proceeds from operation 406 to operation 408.

At operation 408, a determination is made as to whether the de-queued work item 215 is valid. If the work item 215 is invalid, the routine 400 proceeds to operation 410 where the work item is de-queued, but not processed. An error handling mechanism may be implemented to take appropriate actions if the work item is not valid. If the work item 215 is valid, the routine 400 continues from operation 408 to operation 412, where the de-queued work item is processed. For instance, in the case of a work item corresponding to a user data submission, the service 216A may write the submitted data to the fact table 218. From operations 410 and 412, the routine 400 returns to operation 402, described above.

Turning now to FIG. 5, a state diagram showing an illustrative state machine 500 for controlling the state of a WFM system in one embodiment presented herein will be described. As discussed above, the administrative console application program 230 communicates with the various services and software components described above to control the state of operation of the WFM system embodied by the software architecture 200. The operational state of the WFM system determines whether a user may submit data to the WFM system, whether a user may read data from the WFM system, and other aspects of the operation of with the WFM system. The state control mechanism provided by the WFM system ensures data consistency and transactional behavior of work items in the system. The administrative console application program 230 also provides an appropriate user interface for allowing a user to select the operational state of the WFM system. FIG. 5 illustrates various states of operation for the WFM system presented herein that may be specified utilizing the administrative console application program 230.

The state machine 500 begins operation at state 502 which is an initialized state. In the initialized state, the WFM system is prepared and ready to transition to other runtime states, described below. From state 502, the state machine 500 moves to the online state 508. The online state 508 is the normal operational state for the WFM system wherein the WFM system allows work items to be placed on the queues 214, users can read data from the WFM system and write data to the WFM system, and work items may be de-queued from the queues 214. From the online state 514, the WFM system may be placed into the asynchronous offline state 510 or the deleted state 516. In the deleted state 516, the application is deleted and no further processing is performed.

In the asynchronous offline state 510, work items may be placed onto the queues 214. However, services executing within the WFM system are not permitted to de-queue work items from the queues 214. From the asynchronous offline state 510, the WFM system may be placed back into the online state 508, into the offline state 512, or into the locked state 514. In the offline state 512, work items are not placed on the queues 214 or de-queued, and users may not read or write data to or from the WFM system. In the locked state 514, users of the WFM system may read data from the WFM system but not write data. From the offline state 512, the WFM system may be transitioned back to the online state 508, to the asynchronous offline state 510, to the locked state 514, or to the deleted state 516. From the locked state 514, the WFM system may be placed in the online state 508, the asynchronous offline state 510, or the deleted state 516.

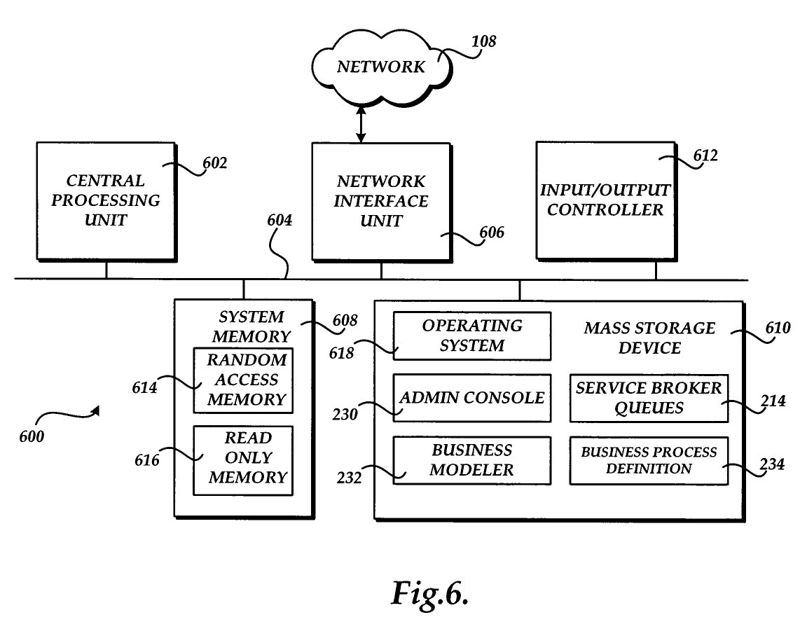

Referring now to FIG. 6, an illustrative computer architecture for a computer 600 capable of executing the software components described above with respect to FIGS. 2-4 will be discussed. The computer architecture shown in FIG. 6 illustrates a conventional desktop, laptop computer, or server computer. The computer architecture shown in FIG. 6 includes a central processing unit 602 (“CPU”), a system memory 608, including a random access memory 614 (“RAM”) and a read-only memory (“ROM”) 616, and a system bus 604 that couples the memory to the CPU 602. A basic input/output system containing the basic routines that help to transfer information between elements within the computer 600, such as during startup, is stored in the ROM 616. The computer 600 further includes a mass storage device 610 for storing an operating system 618, application programs, and other program modules, which will be described in greater detail below.

The mass storage device 610 is connected to the CPU 602 through a mass storage controller (not shown) connected to the bus 604. The mass storage device 610 and its associated computer-readable media provide non-volatile storage for the computer 600. Although the description of computer-readable media contained herein refers to a mass storage device, such as a hard disk or CD-ROM drive, it should be appreciated by those skilled in the art that computer-readable media can be any available media that can be accessed by the computer 600.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 600.

According to various embodiments, the computer 600 may operate in a networked environment using logical connections to remote computers through a network such as the network 108. The computer 600 may connect to the network 108 through a network interface unit 606 connected to the bus 604. It should be appreciated that the network interface unit 606 may also be utilized to connect to other types of networks and remote computer systems. The computer 600 may also include an input/output controller 612 for receiving and processing input from a number of other devices, including a keyboard, mouse, or electronic stylus (not shown in FIG. 6). Similarly, an input/output controller may provide output to a display screen, a printer, or other type of output device (also not shown in FIG. 6).

As mentioned briefly above, a number of program modules and data files may be stored in the mass storage device 610 and RAM 614 of the computer 600, including an operating system suitable or controlling the operation of a networked desktop, laptop, or server computer. The mass storage device 610 and RAM 614 may also store one or more program modules. In particular, the mass storage device 610 and the RAM 614 may store the business modeler 232, the business process definition 234, the service broker queues 214, and the administrative console application program 230, each of which has been described above with reference to FIG. 2. Other program modules may also be stored in the mass storage device 610 and utilized by the computer 600.

Based on the foregoing, it should be appreciated that technologies for providing a scalable WFM system are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for providing scalability in a workflow management system, the method comprising:
providing one or more queues for storing one or more work items to be processed in the workflow management system;
placing the work items on the queues;
de-queuing work items from the queues; and
processing the work items de-queued from the queues.

2. The method of claim 1, wherein the queues comprise a normal queue for storing normal work items in the workflow management system.

3. The method of claim 1, wherein the queues comprise a scheduler queue for storing work items generated according to a time schedule.

4. The method of claim 1, wherein the queues comprise a job queue for storing work items generated by one or more job launching services within the workflow management system.

5. The method of claim 1, wherein placing the work items on the queues comprises asynchronously placing the work items on the queues.

6. The method of claim 1, wherein the work items are placed on the queues according to a time schedule.

7. The method of claim 1, wherein one of the work items comprises a database change list submitted by a client application program.

8. The method of claim 1, further comprising validating the work items after de-queuing the work items from the queues and prior to processing the work items de-queued from the queues.

9. A computer-readable medium having computer-executable instructions stored thereon which, when executed by a computer, will cause the computer to perform the method of claim 1.

10. A system for workflow management, the system comprising:
one or more queues for storing work items;
one or more front-end services for placing work items on the queues; and
one or more back-end services for de-queuing the work items from the queues and for processing the de-queued work items.

11. The system of claim 10, wherein the queues comprise a normal queue for storing normal work items.

12. The system of claim 10, wherein the queues comprise a scheduler queue for storing work items generated according to a time schedule.

13. The system of claim 10, wherein the queues comprise a job queue for storing work items generated by one or more job launching services.

14. The system of claim 10, wherein the front-end services comprise one or more asynchronous request services operative to asynchronously place work items on the queues.

15. The system of claim 10, wherein the front-end services comprise one or more timed request services operative to place work items on the queues according to a time schedule.

16. The system of claim 10, wherein the front-end services are executed on a first group of server computers and wherein the back-end services are executed on a second group of server computers.

17. A method for managing an operational state of a workflow management system, the method comprising:
providing an administrative console application program operative to receive a selection of one of a plurality of states of operation for the workflow management system; and
operating the workflow management system in a state of operation selected through the administrative console application program.

18. The method of claim 17, wherein the states of operation for the workflow management system comprise an online state wherein work items may be placed in one or more queues and removed from the queues and an asynchronous offline state wherein work items may be placed on the queues but are not removed from the queues.

19. The method of claim 18, wherein the states of operation for the workflow management system further comprise a locked state wherein one or more users of the workflow management system may read data from the workflow management system but not write data to the workflow management system.

20. A computer-readable medium having computer-executable instructions stored thereon which, when executed by a computer, will cause the computer to perform the method of claim 17.
